(19) United States
(12) Patent Application Publication
(10) Pub. No.: US 2014/0201213 A1
(43) Pub. Date: Jul. 17, 2014

(54) SYSTEM AND METHOD FOR RANKING ASSET DATA PROBABILITY OF RECOVERY

(71) Applicants: Scott A. Jackson, Palatine, IL (US); Luke Smith, Palatine, IL (US)

(72) Inventors: Scott A. Jackson, Palatine, IL (US); Luke Smith, Palatine, IL (US)

(21) Appl. No.: 14/213,327

(22) Filed: Mar. 14, 2014

Related U.S. Application Data
(63) Continuation-in-part of application No. 13/230,507, filed on Sep. 12, 2011.
(60) Provisional application No. 61/790,221, filed on Mar. 15, 2013.
(60) Provisional application No. 61/409,623, filed on Nov. 3, 2010.

(51) Int. Cl. G06F 17/30

(52) U.S. Cl. CPC G06F 17/3053; G06F 17/30321
USPC 707/741; 707/748

(57) ABSTRACT

A system for determining the probability of recovering an asset is provided. The system includes a data server that receives data corresponding to a plurality of vehicles from a plurality of client sources. A database in operative communication with the data server and stores the received data as information records corresponding to each of the plurality of vehicles. A user interface is in operative communication with the data server and receives a request for historical vehicle data relating to a plurality of vehicle assets. An output processor operatively coupled to the data server and generates recoverability indices for the plurality of vehicle assets.

### CROSS-REFERENCE TO RELATED APPLICATIONS

This application claims the benefit of priority from provisional patent application Ser. No. 61/790,221 (Docket no. 14094-022), filed on Mar. 15, 2013, and is a continuation-in-part of prior U.S. patent application Ser. No. 13/230,507 (Docket no. 14094-018), filed on Sep. 12, 2011, which claims the benefit of priority from provisional patent application Ser. No. 61/409,623 (Docket no. 14094-006), filed on Nov. 3, 2010, each of which is hereby incorporated by reference in its entirety.

### BACKGROUND OF THE INVENTION

1. Technical Field

The present disclosure relates to systems for identifying motor vehicles and to systems for providing information about stolen vehicles and vehicles subject to repossession. In particular, this disclosure relates to systems and methods for ranking asset data, such as motor vehicles, based on probability of recovery.

2. Background

Vehicles may be repossessed when a borrower is delinquent in payment of a loan or other contractual agreement. In a common scenario, if the borrower cannot timely service the loan and is delinquent in payments, the creditor may seek to repossess the vehicle, either directly or more commonly, through an affiliated repossession company.

The borrower may willingly relinquish possession of the vehicle to the repossession company. In such circumstances, the repossession company may take possession of the vehicle at the debtor's residence. In other situations, the debtor may not willingly relinquish possession of the vehicle, and may hide the vehicle or otherwise maintain the vehicle at an undisclosed location away from his or her place of residence. This renders it difficult for the repossession company to locate the vehicle.

Further, when a vehicle to be repossessed cannot be easily located, agents, “skip-tracers,” and “spotters” associated with the repossession company may randomly view the license plates of vehicles in areas known to be frequented by the debtor, often based on the description of the vehicle. However this is very expensive, inefficient and time-consuming because the agent, spotter, or skip-tracer may have a set of documents for each vehicle to be repossessed, and must cross-reference the documents in his possession with each suspect license plate that he or she views while driving or while a passenger in a spotter vehicle. Additionally, using agent, spotter, or skip-tracer is inherently unreliable because it necessarily depends on the agent, spotter, or skip-tracer's ability to locate and accurately identify a vehicle.

A situation may also arise where a borrower wishes to liquidate or transfer a right of possession in a vehicle to a third-party. Given the inherent limitations and uncertainty in using agents, spotters, or skip-tracers to locate a vehicle, a creditor is unlikely to be able to accurately measure their ability to recover a vehicle in the event of default. Because of this, the creditor and potential purchasers of the debt obligation are unable to reliably project the value of the loan or other contractual agreement and may therefore fail to come to agreement for the sale of a portfolio or individual loan obligation.

### SUMMARY

A system for determining the probability of recovering an asset includes a data server that receives data corresponding to a plurality of vehicles from a plurality of client sources. A database in operative communication with the data server and stores the received data as information records corresponding to each of the plurality of vehicles. A user interface is in operative communication with the data server and receives a request for historical vehicle data relating to a plurality of vehicle assets. An output processor operatively coupled to the data server and generates recoverability indices for the plurality of vehicle assets.

In another aspect, a non-transitory computer readable storage medium is provided having stored therein data representing instructions executable by a programmed processor for determining the probability of recovering an asset. The storage medium includes instructions operative for receiving data corresponding to a plurality of vehicle from a plurality of client sources and storing the received data as information records corresponding to each of a plurality of vehicles. A request for historical vehicle data relating to a plurality of targeted vehicle assets is received. The storage medium includes instructions for generating a recoverability score for the plurality of targeted vehicle assets and outputting an index representing a likelihood that the plurality of targeted vehicle assets may be recovered.

In further aspects, a computer-implemented method using at least one processor for determining the probability of recovering a vehicle asset is provided. The method includes receiving a request for historical data relating to a plurality of vehicle assets and processing the request to identify a plurality of targeted vehicles. Data records for the plurality of targeted vehicles identifying a vehicle and a geographic location of the vehicle are retrieved. The data records are processed to generate a recoverability index representing the likelihood of recovering the vehicle.

### BRIEF DESCRIPTION OF THE DRAWINGS

The system may be better understood with reference to the following drawings and the description. The components in the figures are not necessarily to scale, emphasis instead being placed upon illustrating the principles of the invention. Moreover, in the figures, like-referenced numerals designate corresponding parts throughout the different views.

FIG. 1 is a block diagram of an exemplary vehicle tracking and locating system according to one embodiment.

FIG. 2 is a block diagram of an exemplary request server according to one embodiment.

FIG. 3 is a block diagram of an exemplary database controller according to one embodiment.

FIG. 4 is a block diagram of an exemplary video and image feed system according to one embodiment.

FIG. 5 is a block diagram of an exemplary computer system or server according to one embodiment.

FIG. 6 is a flowchart illustrating an exemplary process of the vehicle tracking and locating system according to one embodiment.

FIG. 7 is a block diagram of an exemplary data aggregation environment according to one embodiment.

FIG. 8 is a flowchart illustrating an exemplary process of receiving repossession leads and identifying recoverability probabilities.

FIG. 9 is a flowchart illustrating an exemplary process of utilizing recoverability probabilities to value portfolio assets.

FIG. 10 is an exemplary illustration of a recoverability index that may be generated according to one embodiment.

### DETAILED DESCRIPTION

By way of introduction, creditors may maintain portfolios of loans that include security interests in various assets. Loan portfolios represent major assets of banks, thrifts, and other lending institutions. Creditor portfolios may contain, among other things, loans and other contractual obligations covering vehicles and other similar assets. These portfolios generally include assets that are in good standing, assets that may be approaching delinquency, or assets which may already be delinquent. The value of loan portfolios depends not only on the principal balance and amount of interested owed for each underlying debt obligation, but also on the quality or likelihood that the interest and principal will be paid, or that the collateral may be recovered in the event of default.

In the typical scenario, loan portfolios are valued based on objective data and historical measures of performance, such as the average creditworthiness of the respective debtors and the correlations between various levels of creditworthiness and historical default rates. Valuation of loan portfolios may also consider migration of the underlying debtors and their contractual obligations through various risk classifications. In the case of vehicle loans, a creditor can also benefit from the ability of the methods and systems described by the present disclosure to track and locate vehicles. In addition to identifying vehicles that are subject to repossession, the system may also utilize tracking data to determine the probability of an asset's recoverability. Among other applications, a creditor may benefit using from tracking information and recoverability probabilities to more accurately value loan portfolios, such as by determining the probability that secured assets could be recovered in the event of default.

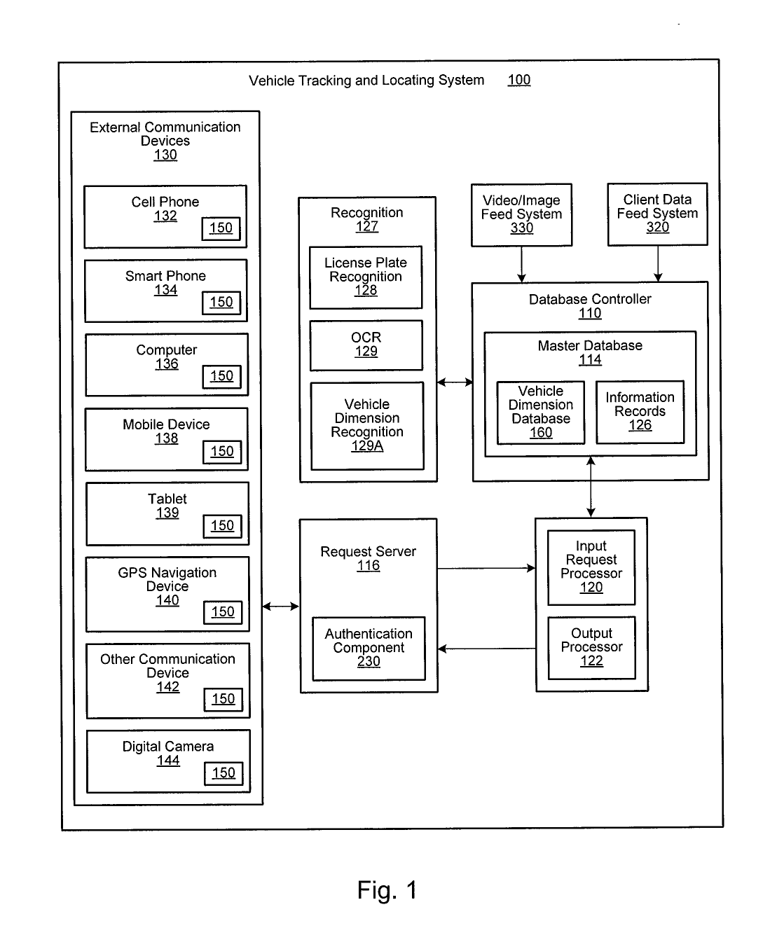

FIG. 1 illustrates a vehicle tracking and locating system 100 that permits a user to obtain information relating to a vehicle of interest. A vehicle of interest may be a stolen vehicle, a vehicle subject to repossession, or any vehicle for which further information is sought by the user. A vehicle of interest may also relate to any vehicle associated with a marketing effort or advertising campaign. A vehicle of interest may be an asset included in a loan portfolio of a creditor.

The vehicle tracking and locating system 100 includes a database controller 110 in operative communication with a master database 114, a request server 116 configured to receive a data request from a user or agent, an input request processor 120 operatively coupled to the request server 116, and an output processor 122 operatively coupled to the request server 116 and configured to provide data of interest from information records 126 stored in the master database 114.

A recognition module 127, may be operatively coupled to the request server 116 and to the database controller 110, and may further include a license plate recognition system (LPRS) 128 or ALPR system (automatic license plate recognition), an optical character recognition system 129, and a dimensional recognition system 129A.

Users may communicate with the request server 116 using a variety of remote or external communication devices 130 to transmit a data request to the request server 116 regarding a particular vehicle of interest. The external communication devices 130 may be wireless devices and/or wired devices, such as cellular telephones 132, smart phones 134, computers 136, mobile devices 138, tablets 139, a GPS navigation device 140, or any suitable communication device 142. The user may transmit a data request by inputting: a vehicle identification number (VIN), a license plate number, a photographic image of a license plate or the vehicle itself, or a video containing images of the vehicle and its associated license plate, as captured by the communication device 130 or by a digital camera 144.

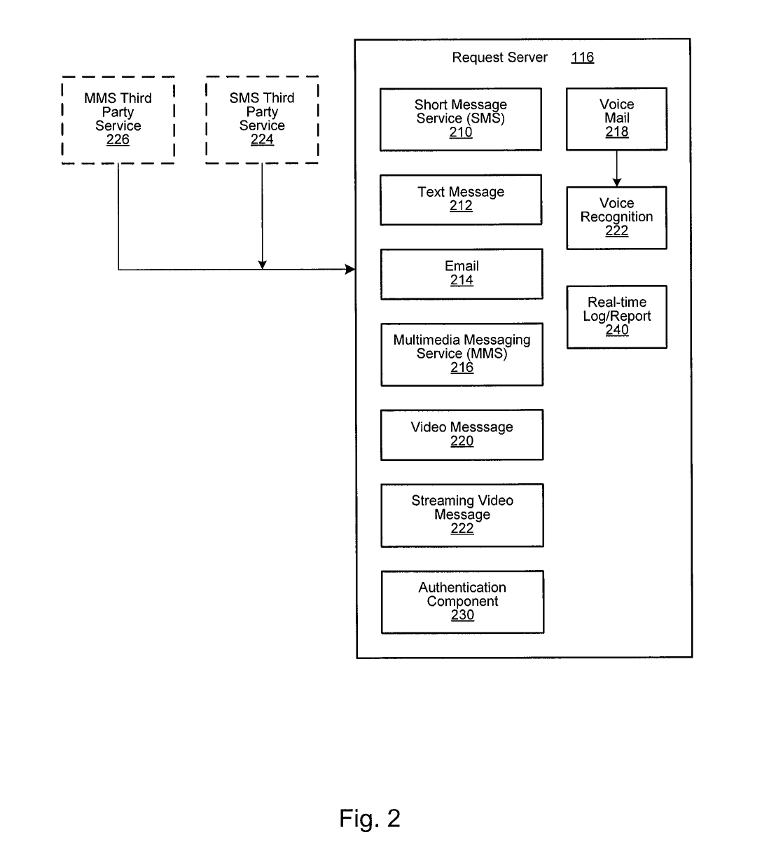

Referring to FIG. 2, when the request server 116 receives the request from the user, the request may be in a variety of different formats using different communication protocols depending upon the type of external communication device 130 that is used and the communication mode in which it is operating. The dataflow may include varied protocols and message formats handled by hardware or software modules or components, such as a short message service (SMS) module 210, a text message module 212, an email message module 214, a multimedia message service (MMS) module 216, a voicemail (VM) module 218, a video module 220, or a streaming video module 222, for example. Any suitable component or module may be used to decode, format, and process the message received. The SMS module 210 may be a SMS server dedicated to receiving and processing SMS communication, while the MMS module 216 may be an MMS server dedicated to receiving and processing MMS communication.

Each of the requests or messages from the user is preferably decoded and handled by the input message component or handler directed toward that particular protocol or message format. Further, a voice recognition system 222 may be coupled to the voicemail module 218 to convert the voice message into a text message so that the text message can be provided to the request server 116. The request server 116 may include an authentication component 230 configured to verify and authenticate that the requesting user is authorized to access the vehicle tracking and locating system 100. A real-time log 240 may also be generated and maintained by the request server 116.

Such input message modules (210, 212, 214, 216, 218) or handlers, whether hardware, software, a combination of hardware or software, may be resident within the request server 116 or within another component of the vehicle tracking and locating system 100, or may be separate and independent from the vehicle tracking and locating system 100.

Alternatively, some input message components or handlers, services, and functions may be provided by a third-party or third-party component. The short message service (SMS) service module 210 may be provided by or replaced by an independent third-party SMS messaging service 224, and may be external to the vehicle tracking and locating system 100. The third-party SMS messaging service 224 may be provided by an entity referred to as “TextMeForBusiness.com.” Such third-party SMS providers 224 essentially host the SMS transactions and provide the necessary infrastructure to manage and service the SMS transactions, such as text to screen formatting, auto-response, message formatting, and other features. Such third party providers receive the data request from the external communication devices 130, and decode, extract, format, and forward the user message to the request server 116.

Similarly, a third party MMS (multi-media service) provider 226 may replace the multi-media messaging service module 216 in the request server 116, and may be external to the vehicle tracking and locating system 100. Such third-party MMS providers 226 essentially host the MMS transactions and provide the necessary infrastructure to manage and service the MMS transactions, such as text to screen formatting, auto-response, message formatting, and other features. Such third party providers receive the data request from the external communication devices 130, and decode, extract, format, and forward the user message to the request server 116. As referred to herein, the SMS service module 210 may be used interchangeably with the SMS third party provider service 224 because the end result is essentially similar, that is, the message is received and processed. Similarly, the MMS service module 216 may be used interchangeably with the MMS third party provider service 226.

As an overview regarding the user process for accessing the vehicle tracking and locating system 100, the following example involves use of the SMS format, but is applicable to any embodiment utilizing a different message format. In this example, the user may type a plurality of digits, such as a multi-digit access code, into the external communication device 130, such as a cellular telephone 132, smart phone 134, or any other communication device, which directs the call to the short message services (SMS) module 210 or to the SMS third party provider 224, for example. In response, the SMS module 210 or the SMS third party service provider 224 requests that the user provide a query, assuming that the user is authorized to access the system.

The user or agent may respond by entering “plate=333ABCD.” This informs the vehicle tracking and locating system 100 that the user is inquiring about a license plate number. Alternatively, the user may respond by entering the VIN number. Further, the user may respond by attaching a photographic image, a video stream, or any attachment containing the license plate number for which further information is desired, as will be discussed in greater detail below.

The SMS third party service provider 224 decodes and formats the request to the request server 116, which in turn, obtains the requested information from the master database 114 via a database lookup. If the requested license plate number is found in the database, information about the corresponding vehicle is provided to the user via the SMS third party service provider 224 or in another format as provided via output processor 122. Such information includes, for example, data about a possible repossession action or stolen vehicle action, the registered owner of the vehicle, name of debtor or lien-holder, lien status, vehicle insurance status, vehicle year, vehicle make, vehicle model, vehicle color, VIN number, associated finance company, date that vehicle entered a repossession list or a stolen vehicle list, case number, location status (address and/or GPS coordinates), law enforcement status (stolen, owner APB, predator in a restricted area, etc.), and the like. Also, when a match is found, the system may transmit an electronic copy of the documents corresponding to the vehicle of interest.

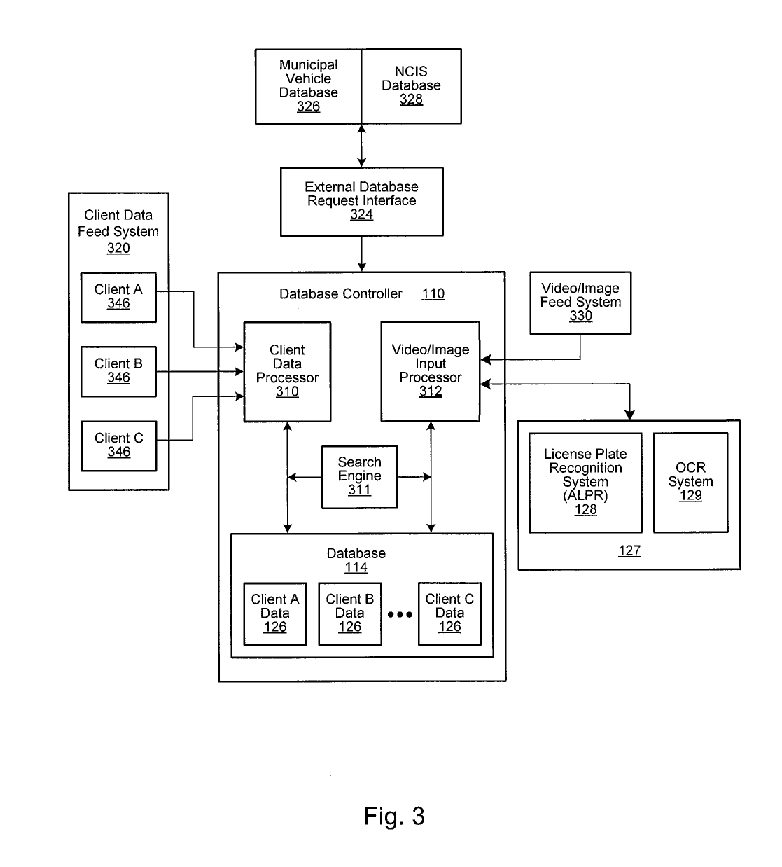

Referring to FIG. 3, one embodiment of the database controller 110 is illustrated. The database controller 110 includes a client data processor 310, a search engine 311, and a video and image input processor 312 operatively coupled to the master database 114. The client data processor 310 may receive input from a client data feed system 320, while the video and image input processor 312 may receive input from a video/image feed system 330, the license plate recognition system 128, and an optical character recognition system 129.

The master database 114 may be updated based on input from the client data feed system 320, which includes multiple “clients” 346. Such clients 346 may represent the various credit companies, banking entities, finance credit companies, vehicle credit agencies, and law enforcement agencies, which may have agreements in place with owner of the vehicle tracking and locating system 100. Such clients 346 or third-party entities provide data to the master database 114 through the database controller 110 based on vehicles that are subject to repossession for nonpayment of loans with respect to banking and credit agencies, while law enforcement may provide additional data with respect to stolen vehicles. Alternatively, the database controller 110 may access remote databases through an external database request interface or communication link 324. The database controller may request information from external databases, such as municipal vehicle databases 326 and the National Crime Information Center (NCIC) database 328, which maintains a record of all vehicles reported stolen in the United States, and other municipal, state, and Federal databases.

The client data feed system 320 facilitates data transfer from the clients 346, including documents and messages. The data may be in the form of CSV files (comma separated value), PDF documents, or may be any suitable data format. The database controller 110 may create, update, and/or delete information records in the master database 114 based on the information received from the clients 346. The documents and data may be transmitted using standard file transfer protocol, such as FTP, for example.

In one specific embodiment, the master database 114 may be segmented or divided into separate logical data areas corresponding to the specific client source. For example, a first client may be TRW Credit Corp., while a second client may be GE Credit Corp. The master database 114 may be segmented for security and privacy considerations because if a vehicle is subject to repossession with respect to a first client, only repossession agencies authorized by that first client are permitted to access the corresponding information and engage in action related to the repossession of the subject vehicle.

In some embodiments, a user may be denied information about a vehicle subject to repossession if that user is not authorized by the client 346. Thus, in one embodiment, such a user may not even be informed by the vehicle tracking and locating system 100 that a requested vehicle license plates corresponds to a vehicle subject repossession if that user is not authorized by the client to receive such information. Accordingly, even if a particular vehicle is subject to a repossession order, if the user inquiring about that that license plate number is not a member of one of the repossession companies authorized to handle repossession of that car, that user may not receive an affirmative indication that the vehicle is subject to repossession. Alternatively, the user may be given an indication that the vehicle is subject to repossession but that the requesting user is not authorized to go forward with the associated repossession.

In other embodiments, rather than logically or physically segmenting the master database 114, the information records 126 may instead be tagged or associated with the corresponding client 346. The search engine 311 may inspect the associated client identifier and provide requested information only if there is a match between the information record associated with the client 346 and the authorization status of the user requesting the information.

The database controller 110 may provide access to the master database 114 on a multi-tier basis. For example, authentication and access may be provided based on three access levels, such as a master administrator level, a manager level, and a user level, each with different privileges and access rights.

Master administrator rights are typically granted to selected employees of the company that own and control the master database 114. The master administrator determines which users and managers are able to obtain data regarding vehicle subject repossession based upon arrangements between clients 346 and the third-party repossession companies.

The master administrator is responsible for accepting or pre-authorizing dial-in telephone numbers, authorized IP addresses, or other external communication device 130 identifiers corresponding to the various users. The master administrator can create, delete, and manage the user-level and the manager-level accounts. Further, the master administrator may set a particular maximum number of users and managers in the vehicle tracking and locating system 100.

The master administrator may also access the real-time log 240 that is maintained by the vehicle tracking and locating system 100. The real time log 240 may record all of the queries requested by the users, and all the responses provided to the users. The report may indicate the frequency of successful license plate number matches and statistics surrounding the matching process, such as the number of matches per 100 queries, and the like. Such statistics may also include geographical data so that the success rate for matches can be correlated with various geographical locations.

The manager-level entity is typically a member of an external repossession company, which may employ for example, ten users, agents, or drivers. A technician at the external repossession company may be considered to be a manager, and such a manager is typically able to provide authorization to the various users or drivers, under authorization from the master administrator.

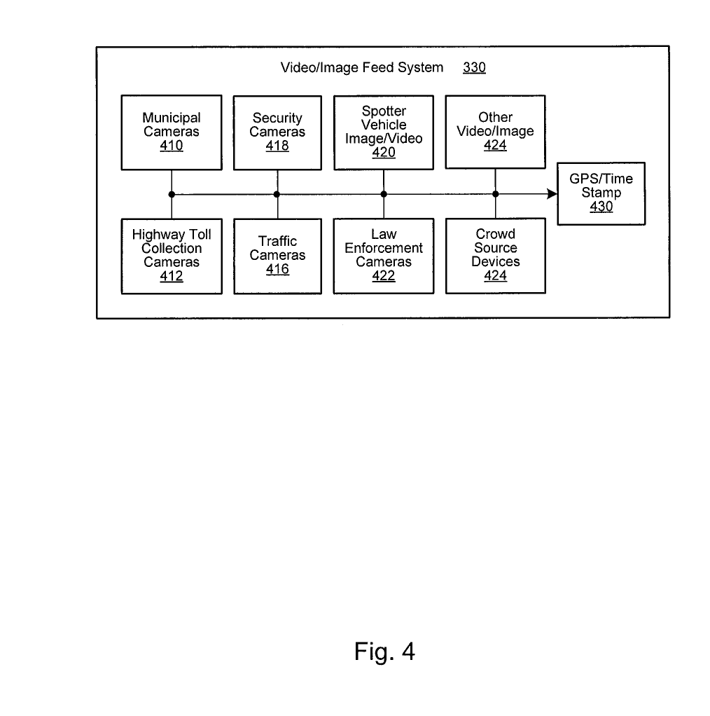

The video and image input processor 312 of the database controller 110 receives video and image data from the video/image feed system 330. The video/image feed system 330 is shown in greater detail in FIG. 4. The video/image feed system 330 provides a real-time data stream of license plate data for storage in the master database 114.

The video data and image data may be received from a plurality of sources, such as from municipal cameras 410, highway toll-collection cameras 412, traffic cameras 416, security cameras 418, spotter vehicle cameras 420, law enforcement cameras 422, “crowd-source” external devices 424, and other video image capture devices 424, which may correspond to mobile image capture devices or fixed image capture devices. Spotter vehicle cameras 420 are typically mounted on “spotter cars” and/or tow trucks, which may continuously capture images of vehicles and their license plates as the spotter vehicles drive along streets, travel through parking lots, and along other access routes.

Once the images of the vehicles and their license plates are captured, by whatever means available, automatic license plate recognition processing may be applied to the images to isolate, extract, and identify the license plate number prior to storage in the master database 114, along with the time and date that the image was captured, and including the geographical location or coordinates of the image capture. To facilitate this process, the license plate recognition system 128 (ALPR) and the OCR system 129 may be operatively coupled to the video and image input processor 312.

The automatic license plate recognition system (ALPR) 128 may be a commercially available recognition system embodied either in hardware components and/or software components. For example, the license plate recognition system 128 may be commercially available from PIPS Technology, a Federal Signal Company, of Knoxville, Tenn. Software processing modules to facilitate ALPR may also be commercially available from Inex/Zamir of Knoxville, Tenn., under the name of Insignia software.

In one embodiment, the video images are transmitted with an indication of a time and date that the image was captured in addition to the geographic location where the image was captured. The geographic location may be provided by an associated GPS system 430 coupled to the image capture device. Alternatively, for fixed image capture devices, a known geographical location of the fixed camera may be transmitted, or an identifying number of the fixed camera may be transmitted so that the vehicle tracking and locating system 100 can assign a predetermined geographical location to the fixed image capture device.

As described above, the user may transmit a data request to the request server 116 by inputting a vehicle identification number (VIN) or a license plate number. Using the external communication device 130, such as a digital camera, the user may also capture an image of the license plate number and transmit a photographic image of a license plate number to the request server 116. A video stream may also be captured. The input request processor 120 may transmit the image or the video stream to the video and image input processor 312 of the database controller, which in turn, may utilize the license plate recognition system 128 and/or the OCR system 129 to convert the photographic image into a license plate number suitable for storage in the master database 114.

As described above, the user may direct an MMS message to either the multimedia messaging service module 216 or to the MMS third party service provider 226. The MMS data format is more complex than a text message because the information requested is usually embedded in an image or series of images (video stream), and must be extracted using some form of recognition processing, such as the license plate recognition system 128 and/or the optical character recognition system 129. Once the MMS message has been received by the MMS service module 216 each image or each frame of the video stream is analyzed to locate and isolate the portion of the image that contains the license plate image.

The OCR recognition system 129 may be used to determine the particular portion of the image that contains characters, such as the license plate. The OCR recognition system 129 may crop and discard the portion of the image that is determined not to contain text data. The OCR recognition system 129 may be a color OCR system or an infrared OCR system. Alternatively, if the image as originally captured has a tight-focus, meaning that the image captured only includes the image of the license plate, the image may be transmitted directly to the license plate recognition system 128 without preprocessing by the OCR recognition system to isolate the license plate.

In another embodiment, the OCR recognition system 129 may be incorporated into the ALPR system 128. The ALPR system 128 may then analyze the image of the license plate to convert the image to alphanumeric characters representing the license plate number.

The following is an example of an agent or a spotter using a mobile device, such as a smart phone 134, to transmit MMS data to the vehicle tracking and locating system 100. The agent or user may walk through parking garage or public area, or may be a passenger in a moving vehicle, and may point the hand-held mobile device 130 (external communication device) toward parked or moving vehicles to capture images of the license plates.

The smart phone 134 may be recording and saving the video stream in memory or may be streaming the video in real-time through a cellular connection to the MMS third party service provider 226 or the MMS service module 216. In this way, each image or sequence of images is processed by the vehicle tracking and locating system 100 to isolate the plurality of license plate numbers captured.

Each license plate number captured is forwarded to the database controller 110 to perform a data match and or save the data if it does not exist in the database 114. Preferably, all license plate numbers are saved in the master database 114 along with the time that the image was captured and the location of capture based upon the GPS tag associated with the data transmission.

In one embodiment, to reduce the storage requirements of the database 114, certain license plate numbers may be deleted if they are “stale,” meaning that the associated timestamp is very old. Whether the external communication device 130 is streaming the video in real-time or whether it is transmitting the recorded video or still frame image at a later time from memory, the MMS module 216 analyzes the images on a frame-by-frame basis.

Turning back to FIG. 2, the request server 116 may provide the authentication component 230, which includes login control and verification. In one embodiment, the user is not required to affirmatively log-in. Rather, using caller-ID, IP address confirmation, or a similar process, the authentication component 230 may recognize the phone number or internet address of the caller or other identification of the external communication device 130, which has been preauthorized for acceptance by the authentication component 230. Each telephone or other communication device 130 is preferably authorized in advance for acceptance by the authorization component 230.

Alternatively, the authorization component 230 need be not be resident in the request server 116 or in the vehicle tracking and locating system 100, and may be provided by a third-party component or service, such as the SMS third party service provided 224 or the MMS third party service provider 226 discussed above. Any third-party provider may assist in authenticating the user.

In another embodiment, when the user places a call to the request server 116, the request server transmits a display interface or GUI to the user, and the user may then provide a security code or other password to gain access to vehicle tracking and locating system 100. Of course, the third-party component or service such as the SMS or MMS third party service provider 224, 226 may also transmit the display interface or GUI to the user.

Once the user has transmitted a request to the request server and 116 and has been properly authenticated, the search engine 311 determines if the requested license plate number is found in the database, subject to the above-described criteria for permitting the user to obtain access to information. If a match is found, the output processor 122 organizes and transmits the data of interest to the user in one of a variety of possible formats, depending upon the format in which the request was received.

The data of interest may be transmitted as text, a synthesized voice message based on text, and may also be transmitted in the form of documents, such as in PDF format, JPG format, or document text format, or in other suitable electronic format. The data of interest may include information about the vehicle, including vehicle year, vehicle make, vehicle color, vehicle model, vehicle owner, lien holder, vehicle identification number, vehicle location history, case number, date of repossession action, reporting agency, credit agency, date stolen if applicable, and the like.

As shown in FIG. 1, each external communication device 130 may include a resident application or “App,” 150 which is a specific plug-in or software module installed on the external communication device 130 to facilitate the above communication process. Preferably, the application 150 is installed on a smart phone, tablet, or other device having an operating system used by a large number of people. For example, mobile devices using the Google's Android™ operating system or Apple's iOS™ operating system may implement the application 150.

The application 150 increases the efficiency and flexibility of the system 100, minimizes use of customized hardware and software to reduce cost, and increases user or agent convenience, satisfaction, and efficiency. Such an application 150 may replace customized software modules, and provides a uniform interface to the user or agent. Further, because most external communication devices 130, such as smart phones 134, are GPS-enabled, images and video captured by such devices can be tagged with the GPS coordinates so that the location of the image (vehicle) captured is associated with its corresponding location.

Such applications 150 may be used by the agent, or by the members of the general population that receive compensation to provide video or images to the vehicle tracking and location system 100. This is referred to as “crowd-sourcing,” that is, employing the masses or general population as spotters to participate in providing data to the vehicle tracking and locating system 100. For example, students may be paid a commensurate amount to record and/or stream video images of the areas in which they travel using external communication devices 130 they own.

Such video may be recorded for subsequent transmission, or may be transmitted in real-time to the vehicle tracking and locating system 100. The student need only download the application 150 to his or her mobile device and activate the application to permit the device to record any and all images. In one embodiment, the participating students or spotters may be paid a stipend depending upon the volume of recorded information. In another embodiment, to encourage higher-quality information, the students may be paid a percentage of fees received if the information provided by the student is used in an actual repossession or identification of a vehicle in question.

Embodiments of the vehicle tracking and locating system 100 are not limited to finding only vehicles of interest, such as vehicles subject to repossession. The vehicle tracking and locating system 100 may also find application in parking enforcement. For example, a parking enforcement officer or agent may have an external communication device 130, such as a smart phone 134, for which the above-described application 150 is installed.

The officer or agent may travel past many parked vehicles while the smart phone 134 streams video data or still photographs to the vehicle tracking and locating system 100, preferably in MMS format. Based upon a recorded images of the plurality of license plates, the vehicle tracking and locating system 100 may isolate, recognize and identify each license plate number and compare the license plate numbers to the municipal vehicle database 326 operated by a municipality or other government body. The municipal vehicle database 326 may contain records corresponding to vehicles having outstanding parking or other violations. The vehicle tracking and locating system 100 may also request data from the National Crime Information Center (NCIC) database 328.

Based on a match between the license plate number recognized and the license plate number contained in the database, the output processor 122 may provide an output to a parking meter enforcement agent that confirms that a vehicle scanned has outstanding tickets, and thus should be impounded or booted with a Denver Boot™ or similar immobilization device. The parking officer or agent may receive a graphic output or notification directly on the smart phone 134 or display device. Alternatively, the smart phone 134 may be coupled to a wireless or wired printer so that a hardcopy can be printed. If the officer or agent has printing capability, a further citation maybe printed and issued and a affixed to the vehicle in lieu of impoundment.

In another embodiment, the automatic license plate recognition system 128 (ALPR) may be used in conjunction with the dimensional recognition or object recognition system 129A so that the dimensions or general shape of the vehicle may be identified and quantified. In this way, a license plate number recognized can be compared to the municipal vehicle database 326 to verify that the license plate indeed belongs to that specific type of vehicle to which it is affixed. For example, once the license plate number has been recognized, the make and model of the vehicle may be obtained from the official vehicle registration database 326.

A vehicle dimension database 160 (FIG. 1) may be part of or may be included in the master database 114 or may be separate therefrom. The vehicle dimension database 160 may include information as to the overall dimensions of every make and model of vehicle. In operation, when the license plate recognition system 128 (ALPR) extracts the license plate number of a particular vehicle, it may instruct the database controller 110 to request the make and model of that vehicle from the municipal vehicle database 326 or other database containing official vehicle registration information, if such information is not already of record in the master database 114. Of course, the request for information from the municipal vehicle database 326 need not necessarily be made by the database controller 110, but rather, may be made by the request server 116 or other component of the vehicle tracking and locating system 100.

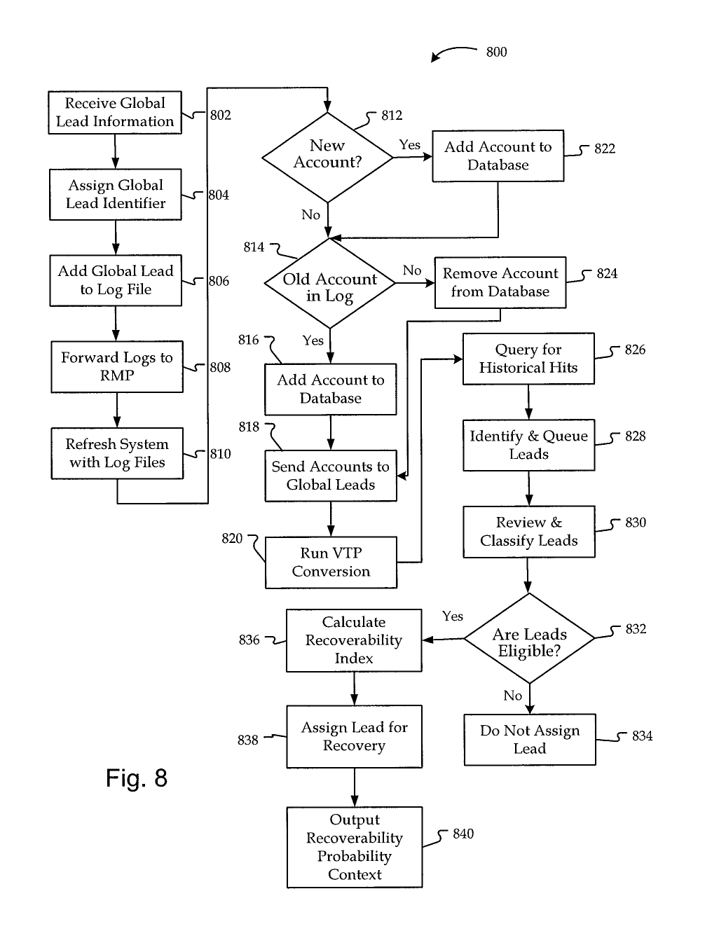

In one embodiment, for example, if the municipal vehicle database 326 indicates that the vehicle scanned is a Volkswagen, but the vehicle dimension database 160 indicates that the size of the vehicle corresponding to the license plate number is much larger than a Volkswagen, an alert can be issued indicating that the license plate may be stolen and is affixed to the wrong vehicle. The system may also use additional vehicle information retrieved from the dimension database 160 and municipal vehicle database 326, as well other public databases containing official vehicle information, to assist in identifying license plates that are affixed to the wrong vehicle. For example, the system may retrieve vehicle information relating to color, size, make, model, series, or any other identifying information and may use this information to identify license plates located on incorrect vehicles. The system may provide for automatic recognition and comparison of vehicle features, or may place potential matches in a queue for a system administrator to review and verify. In either scenario, the system can store the information identifying mismatched license plates as CPIC (correct plate, incorrect car) leads, as further described in connection with FIG. 8.

In another embodiment, the vehicle tracking and locating system 100 may provide a “proximity alert” for fleet and dispatch management. In this embodiment, the identity of vehicles of interest (whether subject to repossession or of interest for any reason, such as for marketing purposes) are downloaded or imported into a GPS navigation device 140, or map enabled smart phone 134 installed in the agent's or spotter's vehicle. Of course, the GPS navigation device 140, smart phone 134, or other suitable device must have a sufficiently large memory to accommodate all of the data. The GPS navigation device 140 may be a commercially available navigation device, such as those provided by Garmin Corporation.

The GPS navigation device 140 may then compare the current location of the agent's vehicle (in a real-time), against the location of all of the downloaded data corresponding to various vehicles of interest. The GPS navigation device 140 may then compare the location of each vehicle of interest in memory to the current location of the agent's vehicle to determine the distance from the agent's vehicle to the last known location of the vehicle of interest, assuming the time stamp associated with the vehicle of interest is not “stale.”

If the GPS navigation device 140 determines that the vehicle of interest is within a predetermined radius of the agent's vehicle, for example, within one mile, and the time stamp was relatively recent, for example, within five minutes, the GPS navigation device 140 may alert the agent and direct the agent to the last known location of the vehicle of interest.

In that way, the agent could attempt to locate and track the vehicle of interest and take appropriate action. Of course, the predetermined radius and the time stamp differential (i.e., the current time minus the timestamp associated with the vehicle of interest) may be increased or decreased depending upon the application and the scope of the agent's work. Also, to keep the data “fresh,” or up-to-date, the information corresponding to the vehicles of interest are preferably downloaded to the GPS navigation device 140 periodically, such as every 5 minutes, for example.

Alternatively, the data corresponding to the vehicles of interest need not be downloaded and remain resident in the GPS navigation device. Rather, the GPS navigation device may communicate in real-time with the vehicle tracking and location system 100, and may transmit the current location or coordinates of the agent's vehicle to the vehicle tracking and location system, for example every 30 seconds. The vehicle tracking and location system 100 may then compare the location of the agent's vehicle to all of the vehicles of interest in the database 114 based upon the location of the vehicle of interest and the time that the vehicle of interest was spotted.

If the vehicle of interest was spotted within a predetermined radius of the current location of the agent vehicle, and if the time that the vehicle of interest was spotted was relatively recent (i.e. within the last 10 minutes, for example), the vehicle tracking and location system 100 may inform the agent through the GPS navigation device 140 that a vehicle of interest was spotted and may be close by. The GPS navigation device 140 may also provide navigational directions to the agent to facilitate pursuit of the vehicle interest, at least with respect to its last known location.

Note that the vehicle tracking and location system 100 may provide navigational directions to the agent or spotter should the agent not be in possession of a GPS navigational device. Based on the coordinates of a destination, reverse geo-coding can be applied to either the vehicle interest or the agent vehicle. Reverse geo-encoding means that once the GPS coordinates of a destination are known, a map or navigational directions, or an address can be transmitted to the agent's smart phone or other device. In one embodiment, a commercially available reverse geo-coding system, such as Google Maps™, Microsoft Bing On-Line™, Microsoft MapPoint™, Streets & Trips™, or MapQuest™, may be used.

The vehicle tracking and locating system 100 may be embodied as a system cooperating with computer hardware components and/or as computer-implemented methods. The vehicle tracking and locating system 100 may include a plurality of software modules or subsystems. The components, modules, or subsystems, such as the request server 116, the input request processor 120, the output processor 122, the database controller 110, the video and image input processor 312, the client data processor 310, the search engine 311, the license plate recognition system 128, the optical character recognition system 129 and other components and/or modules of the vehicle tracking locating system 100, may be implemented in hardware, software, firmware, or any combination of hardware, software, and firmware.

Such components, modules, or subsystems may or may not reside within a single physical or logical space. For example, the components, modules, or subsystems referred to in this document and which may or may not be shown in the drawings, may be remotely located from each other and may be coupled by a communication network.

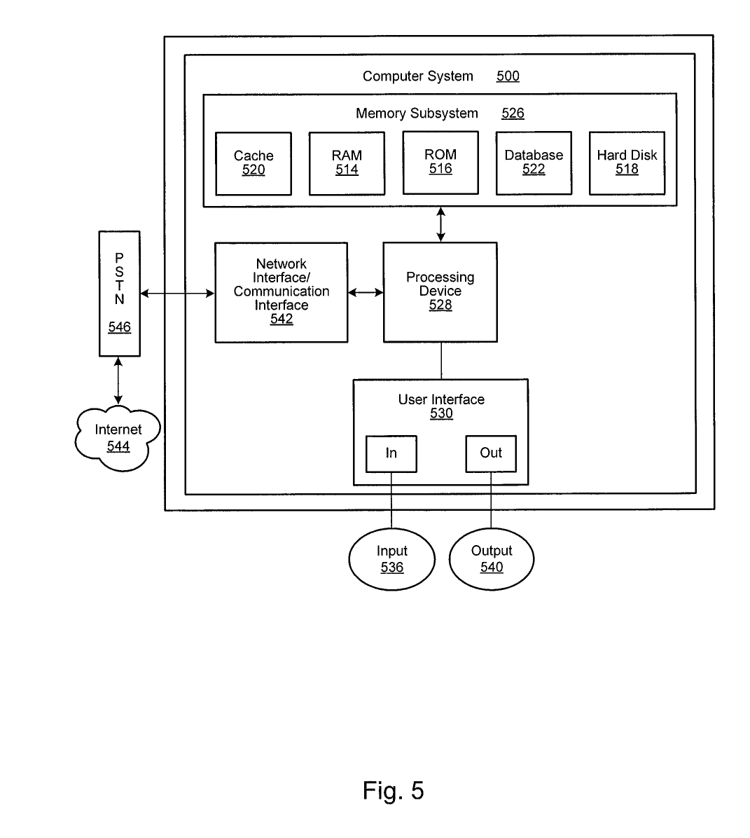

FIG. 5 is a high-level hardware block diagram of one embodiment of a computer system hardware embodiment that may perform some or all of the functions of some of the components, modules, and/or subsystems described above. Such a computer system 500 may be embodied as a system cooperating with computer hardware components and/or as computer-implemented methods and is shown in FIG. 5 as a high-level hardware block diagram of a system computer 500 that may be used to execute software or logic to implement the processing of the components, modules, and/or subsystems described above.

The computer 500 may be a personal computer and may include various hardware components, such as RAM 514, ROM 516, hard disk storage 518, cache memory 520, database storage 522, and the like (also referred to as “memory subsystem 526”). The computer 500 may include any suitable processing device 528, such as a computer, microprocessor, RISC processor (reduced instruction set computer), CISC processor (complex instruction set computer), mainframe computer, work station, single-chip computer, distributed processor, server, controller, micro-controller, discrete logic computer, and the like, as is known in the art. For example, the processing device 528 may be an Intel Pentium® microprocessor, x86 compatible microprocessor, or equivalent device, and may be incorporated into a server, a personal computer, or any suitable computing platform.

The memory subsystem 526 may include any suitable storage components, such as RAM, EPROM (electrically programmable ROM), flash memory, dynamic memory, static memory, FIFO (first-in, first-out) memory, LIFO (last-in, first-out) memory, circular memory, semiconductor memory, bubble memory, buffer memory, disk memory, optical memory, cache memory, and the like. Any suitable form of memory may be used, whether fixed storage on a magnetic medium, storage in a semiconductor device, or remote storage accessible through a communication link. A user or system interface 530 may be coupled to the computer system 500 and may include various input devices 536, such as switches selectable by the system manager and/or a keyboard. The user interface also may include suitable output devices 540, such as an LCD display, a CRT, various LED indicators, a printer, and/or a speech output device, as is known in the art.

To facilitate communication between the computer 500 and external sources or other components, modules, and subsystems, a communication interface 542 may be operatively coupled to the computer system 500. The communication interface 542 may be, for example, a local area network, such as an Ethernet network, intranet, Internet, or other suitable network 544. The communication interface 542 may also be connected to a public switched telephone network (PSTN) 546 or POTS (plain old telephone system), which may facilitate communication via the Internet 544. Any suitable commercially-available communication device or network may be used.

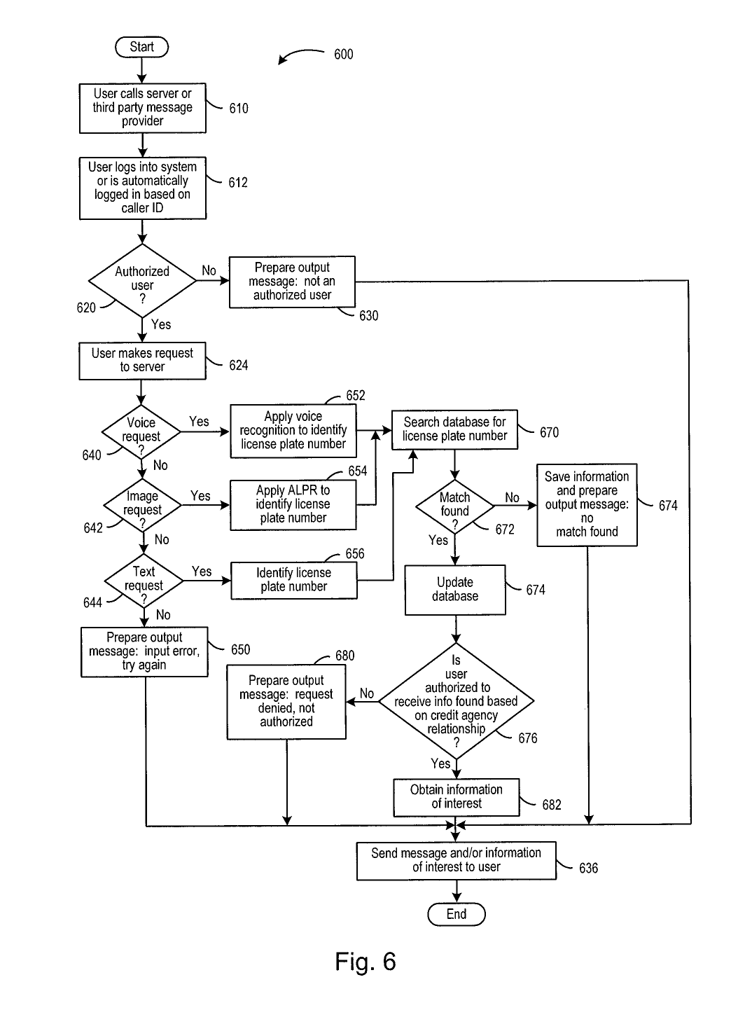

FIG. 6 illustrates a process 600 according to the vehicle tracking and locating system 100. In one embodiment, the user contacts the request server 116 using the external communication device 130, or calls the third-party provider service 224 based on the communication format (610). The user then logs into the vehicle tracking and locating system 100 or, alternatively, is automatically logged in based on caller-ID, IP address, or other identifier (612) corresponding to the external communication device 130.

If the user is authorized (620) to access the vehicle tracking and locating system 100, the user then initiates a request (624) to the request server or third-party provider service 224. If the user is not authorized (620), an output message is prepared indicating that the user is not authorized (630), processing then branches to a component that outputs the prepared message (636), and the routine exits. The component that prepares and/or sends the output message, in some embodiments, may be the output processor 122.

The user may provide the request in a variety of formats, such as a voice request (640), an image request (642), or a text request (644). If the request is not in any of the required formats, an output message is prepared indicating an input request error, which requests that the user try again (650).

If the request is a voice request, voice recognition is applied to identify the text of the request (652), which corresponds to a license plate number. If the request is an image request where the user is transmitting a digital image of a license plate, automatic license plate recognition is applied to identify the license plate number in the request (654). If the request is an video request or streaming video request, the OCR system 129 isolates the portions of the images/frames containing the license plate and forwards the cropped portions to the license plate recognition system 128 so as to identify the license plate number in the request (654). If the request is a text message, license plate number in the message is extracted (656).

Once the license plate number of interest is been extracted and identified, the search engine 311 searches the master database 114 to determine if a match exists (670). In one embodiment, if the request contains video or photographic images, and if no match is found (672), the license plate number and associated information (such as location and time) are saved in the database so as to continuously build the database, and an output message is prepared indicating that no match has been found (674). Processing then branches to the component that outputs the prepared message (636), and the routine exits.

In one embodiment, if the request contains video or photographic images, and if a match is found in the master database (672), the master database is updated with respect to the location and time (674). Next, the matching record is inspected to determine if the user is authorized to view the matching information and/or engage in actions relative to the repossession of the vehicle for which a match is found (676). If the user is not authorized, an output message is prepared indicating that the user is not authorized and that the request is denied (680). Processing then branches to the component that outputs the prepared message (636).

If the user is authorized to view the matching information and/or engage in actions relative to the repossession of the vehicle for which a match is found, the information of interest is obtained from the matching database record (682), and an output message is prepared indicating that the information is available. The output message is then sent to the user along with the information of interest obtained from the database (636), and the routine exits.

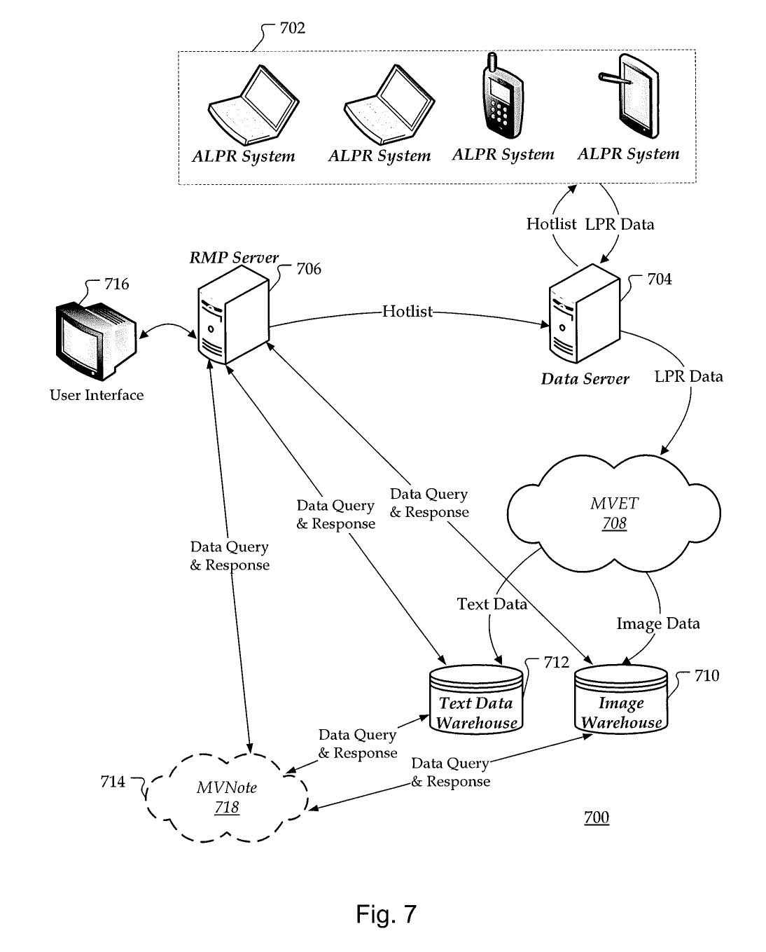

In addition to the aforementioned uses of the methods and systems, the present disclosure describes a system that may be utilized to provide tracking information and recoverability probabilities for vehicles of interest based on aggregated vehicle data. FIG. 7 illustrates an exemplary data aggregation environment 700 according to one embodiment. Data aggregation environment 700 includes ALPR systems 702 in operative communication with data server 704. ALPR systems 702 may be wireless devices and/or wired devices, such as cellular telephones, smart phones, computers, mobile devices, tablets, a GPS navigation device, or any suitable communication device. ALPR systems 702 may be mobile recognition systems, such as those mounted on vehicles, or stationary recognition systems, such as street and intersection recognition devices. ALPR systems 702 may be components of the same ALPR system 128 described in connection with FIG. 1, may include any of the components of video/image feed system 330 described in connection with FIG. 4, or may be additional components to those previously described. In either event, ALPR systems 702 aggregate LPR (license plate recognition) data and transmit the LPR data to data server 704. LPR data may include video images, fixed images, or other information that can be used by a vehicle tracking and locating system, such as vehicle tracking and location system 100 described in connection with FIG. 1 above. In some embodiments, the LPR data may be processed by the video and image input processor 312 which is operatively coupled to ALPR system 128 and the OCR system 129.

Data server 704 stores the LPR data received from ALPR systems 702. Data server 704 may consist of a single data server and database or may be multiple distributed data servers and databases in operative communication over a network, such as the Internet. In certain embodiments, data servers 704 may be implemented in conjunction with manufacturer-specific tools or third-party server management tools. Example tools that data servers 704 may make use of include tools provided by 3M Back Office System Software™ or home-based server software provided by ELSAG™, and the like. Data server 704 may also receive or access data from third-party sources and manufacturers. For example, data server 704 may be in operative communication with municipal vehicle databases 326, NCIS databases 328, or receive data from client data feed systems 320, as well as from other third-party entities. Data server 704 can be a cache server that aggregates and stores all LPR data from the various sources in a format that may be accessed by data extraction tools, such as MVET (Motor Vehicle Extraction and Transmission) tool 708.

In some embodiments, data aggregation environment 700 may include one or more MVET tools 708. MVET tool 708 is a data extraction and transmission tool that can be designed to overlay various components of data server 704 and may be integrated with any of the aforementioned manufacturer-specific or third-party server management tools. MVET 708 may be coupled to one or more processors, servers, and databases to perform the particular data extraction and data processing functionality to be implemented by the MVET tool. Data aggregation environment 700 may include multiple instances of MVET tool 708, each of which may be designed to overlay a subset of components from data servers 704. Regardless of the implementation of data server 704, MVET tool 708 is designed to access and extract data from data servers 704.

MVET tool 708 extracts LPR data from the data server 704. For example, MVET tool 708 may be designed to extract vehicle tracking information, including license plate images and license plate text. The LPR data may be processed by video and image input processor 312 which is operatively coupled to ALPR system 128 and the OCR system 129, as described in connection with FIGS. 1 and 3. MVET tool 708 may then divide and separate the images and text data. The image data can be transmitted to image warehouse 710 and the text data can be transmitted to text data warehouse 712. Image warehouse 710 and text data warehouse 712 may likewise consist of one of more servers and databases. Image warehouse 710 and text data warehouse 712 may be the same data warehouse, or each may consist of multiple distributed data servers and databases in operative communication over a network. An exemplary image data warehouse 710 may include web-based services, such as Amazon S3™. An exemplary text data warehouse 712 may include one or more relationship databases, such as Amazon RDS™. Image data warehouse 710 and text data warehouse 712 may be cloud computing platforms, or may consist of similar offline storage platforms.

Data aggregation environment 700 may also include RMP (recover management pro) server 706. RMP server 706 may be the same server as data server 704 or they may be one or more distributed servers in operative communication over a network, such as the Internet. RMP server 706 is a web-accessible tool that may be in operative communication with image data warehouse 710, text data warehouse 712, MVET 708, and data servers 704. In some embodiments, RMP server 706 may also be in operative communication with MVNote 718, a system component responsible for generating alerts and notifications to be sent to various user devices. RMP server 706 may implement one or more web-based user interfaces 716. Web-based user interfaces 716 may be secure portals that allow a system user to access LPR data, such as the data stored in image data warehouse 710 and text data warehouse 712, and return results specific to that user's needs.

RMP server 706 allows the system to display to a user the results of processing historical LPR data relating to one or more vehicles of interest to that user. In this way, RMP server 706 provides a user interface that can be implemented in accordance with various configurations in order to provide a system user with an interface 716 for displaying historical LPR data in a way that suits that particular user's needs or business goals. For example, in the instance of a user wishing to locate a particular vehicle for repossession, RMP server 706 may provide a mapping feature that displays historical vehicle views as flags or “hits” within a geographic area. As discussed further in connection with FIG. 8, the user interface 716 may also include one or more classifications describing an aspect of the vehicle views, such as the recency of the hit, time of day, frequency, or whether the vehicle was spotted having mismatched license plate data. In some embodiments, RMP server 706 may also generate a hotlist of vehicles of interest. The hotlist may be used to alert ALPR systems of their proximity to vehicles of interest. The hotlist is transmitted back to data servers 706 and downloaded or pushed to ALPR systems 702. In this way, ALPR systems 702 can receive up-to-date information for identifying vehicles of interest during use.

FIG. 8 illustrates an exemplary process 800 of receiving repossession leads and identifying recoverability probabilities. In one embodiment, the system receives global lead information (802) from a system user. The system user may be financial institution, municipality, creditor, insurance company, data collector, third-party subcontractor, or other entity that may be granted access the system. The system assigns a global identification number (804) that allows the system to identify both the lead and the system user that submitted it. The system may store the global lead information to a log file (806) and the log files can be forwarded and uploaded to the RMP server (808).

The RMP server uses the log files to refresh and update the system records (810). The system first determines whether global lead information is from a new user account (812). If the information is from a new user, a new account is generated and added to the database (822). If the information is from a current user account, the system proceeds to the next step. The system next determines whether there are any old accounts in the system that are not present in the log file or that the log otherwise indicates are not currently active user accounts (814). If an old account is located that is no longer present in the log, the account is removed from the system (824) such that the account information, including any vehicles of interest indicated therein, is not processed to generate subsequent alerts. If an old account is present in the log, indicating that the account and leads therein are still active, then the account information is imported into the RMP system and system databases (816).

The system then transfers all imported accounts to the global leads context for processing (818). The global leads context runs VTP (VIN to plate) conversion on all accounts (820) and queries the system databases to retrieve historical information for vehicles of interest (826) using the license plate information determined during the VTP conversion process. The system then processes the historical information and identifies any leads on vehicles of interest (828). In some embodiments, the leads may be automatically processed using algorithmic analysis, or the leads may be placed in a queue for review by a system administrator. In either scenario, the leads are reviewed and classified (830).

Leads are classified to ensure the accuracy of the information generated by the system. Leads may receive a variety of different classifications that are relevant to system users when searching for information on vehicles of interest and which may be determined based on the data the system was able to identify about the vehicle of interest, such as data that may have been generated by object recognition system 129A and stored in vehicle dimension database 160. For example, the lead classifications may include a positive read classification in which the system or administrator is able to identify that a correct license plate has been spotted on a car matching the vehicles details that are associated with the vehicle registration and VIN or retrieved from dimension database 160, municipal vehicle database 326, or any other public database containing official vehicle information. Alternatively, a lead may be classified as CPIC (correct plate, incorrect car). Lead classifications may also take into account geographic considerations, such as the state which the vehicle is registered, in order to classify vehicles spotted in wrong states. In the case of a vehicle having a license plate matching the registration information but located in a state that differs from the vehicle registration, the system may classify the lead as PRIS (positive read, incorrect state). It will be apparent to those of ordinary skill in the art that these classifications are merely exemplary and that additional lead classifications may be used to provide information relevant to the needs of the various system users.

In some embodiments, the system may utilize a confidence level algorithm to determine whether the vehicle was spotted in the correct state or should be classified as PRIS. The confidence level algorithm may primarily consider the geolocation data that was sent from the ALPR device when the vehicle was spotted. For example, the system can compare the received geolocation data, such as latitude and longitude of the spotter vehicle, to the registration information for the vehicle to produce an initial confidence level. However, it may not be possible to positively identify all of the registration information for a particular license plate. Thus, in some embodiments, the system may also consider additional information to help project the likelihood that the vehicle is located in the correct state. Most states issue license plates with a distinct syntax or pattern in the sequence of letters and numbers. For instance, a state may issue license plates having a one letter and two numbers followed by four additional numbers. Thus, an exemplary license plate in this state may be “X12 3456.” By comparing the geolocation data for the vehicle to the syntax of the particular license plate, the system is able to project whether the vehicle is located in the proper state. Notably, it is possible that the syntax for two states may be similar, or that the permutation of a particular syntax on the license plate may be similar to two or more distinct state syntaxes. In this scenario, the system may also use the geolocation to calculate the distance to each state with a potentially matching syntax. If one potentially matching syntax is from a neighboring state and the other is from a state located on the other side of the country, then it is more likely that the vehicle is from the neighboring state. While no one factor is dispositive, the system may consider these factors in addition to other types of data the system is able to determine, such as vehicle make, model, or size, to project a confidence level that the vehicle is located in the correct state. The system may then use this confidence level to classify the lead as PRIS or otherwise. In some embodiments, the classifications may be organized by ranges of confidence level and any classification having a low confidence level may be flagged for human review.

Once the leads are classified, depending on the type of user, the system may then determine if the leads are eligible for recovery or for reporting (832). This step is intended to serve a number of possible functions, including as a quality control mechanism, and may allow the system administrator to specify certain parameter requirements for a valid lead. For example, the system administrator may specify that a lead must be based on LPR data that was read within the last 30 days. If the lead is based on data that is older than 30 days, the information may be stale or outdated and the lead may not be assigned for forwarding or recovery due to the potential for inaccuracies (834). Alternatively or in addition, the system may verify that user inquiring about the particular license plate number or lead is a member of one of the repossession companies authorized to handle repossession of that vehicle. If the lead is based on eligible security interest data, then the system will then calculate the recoverability index for the vehicle of interest (836) and assign the lead, if desired, for recovery (838). Depending on the context of the system user, the system may not assign a lead for recovery, but rather can return the recoverability index for the particular vehicle to be used for as a forecasting measure, such as for generating a recoverability probability. The system may output the recoverability probability in a context that is specific to a particular user's needs (840).

In some embodiments, the recoverability probability may be in the form in of a recoverability score that is generated using the recoverability index by considering only the elements of the recoverability index that are relevant to a particular context or use case. The particular context, however, may be defined dynamically by the user utilizing an interface for specifying relevant criteria, such as user interface 716 or a similar secure web portal. For example, the user may specify one or more criteria or applications of the historical LPR data that are relevant to the user's business goals. The system may automatically generate steps for selecting the relevant index components to meet those goals. Similarly, the particular context for the recoverability score may be defined when the user account is created and the secure web portal and user interface 716 are initially integrated with the APIs of the RMP server 706. Once the interface is integrated with the system APIs, the user may use the interface to specify relevant index components, or the user may work with a system administrator to define the steps for calculating a recoverability score that is customized for that user's needs or business goals. The customized recoverability score algorithm can then be associated with the user's account and the secure web portal accessed by the user. In either scenario, an output processor, which may be output processor 122 described in connection with FIG. 1, can be configured to output the data results in a format tailored to the particular system user.

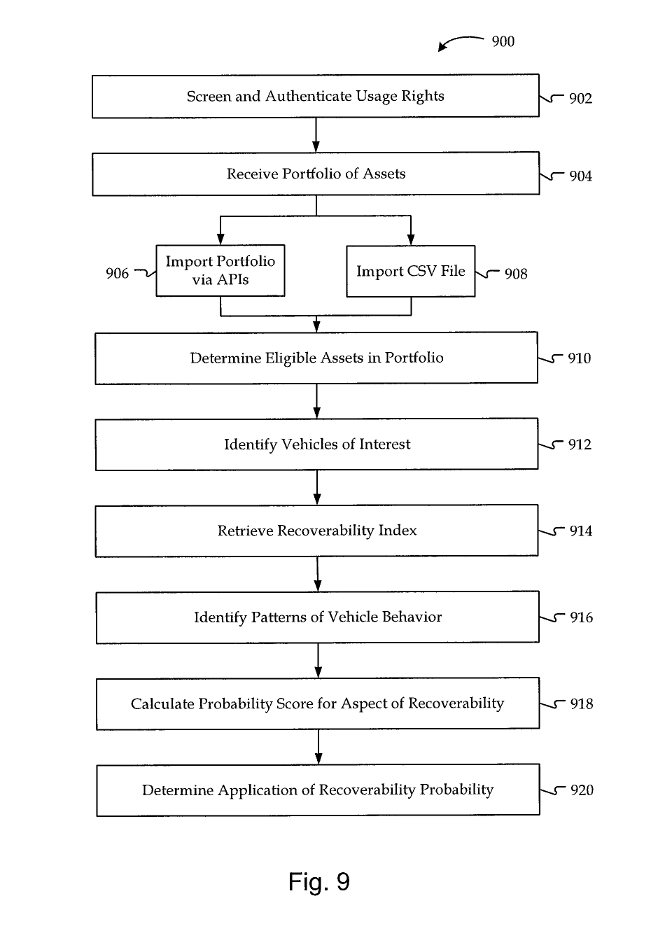

The recoverability index may be determined based on the historical LPR data for a vehicle of interest. Generally, the recoverability index is used to represent the likelihood that the vehicle of interest could be recovered, for example, in the case of a default. The recoverability index, and the recoverability score that is generated from a subset of the index components, may generally reflect the likelihood that a vehicle of interest will be present at a determinable physical location; however, as further described in connection with FIG. 9, the process for generating the recoverability index, as well as any recoverability score therefrom, may be adapted to take into account the various parameters that may be relevant to the business goal of a particular user. For example, the process for generating the recoverability index and the corresponding recoverability score can be adapted based on whether the user is a creditor seeking to determine the likelihood that a vehicle will be recoverable upon default, or whether the user is an insurance company seeking to determine the likelihood that a vehicle is being used in a manner corresponding to the insured risk. In the latter situation, the recoverability index and score may be more likely to consider patterns of vehicle use as they relate to information listed on an insurance policy in order determine the primary use of the vehicle. The recoverability index and scores can be generated with a focus on a single vehicle of interest or may be targeted to a class of vehicles sharing a common characteristic. For example, the insurance company may use the recoverability index to assess vehicle risk for certain types of vehicles or consumers, as well as to generate improved actuarial classes for risk management, although additional uses are contemplated within the scope and spirit of the present description.

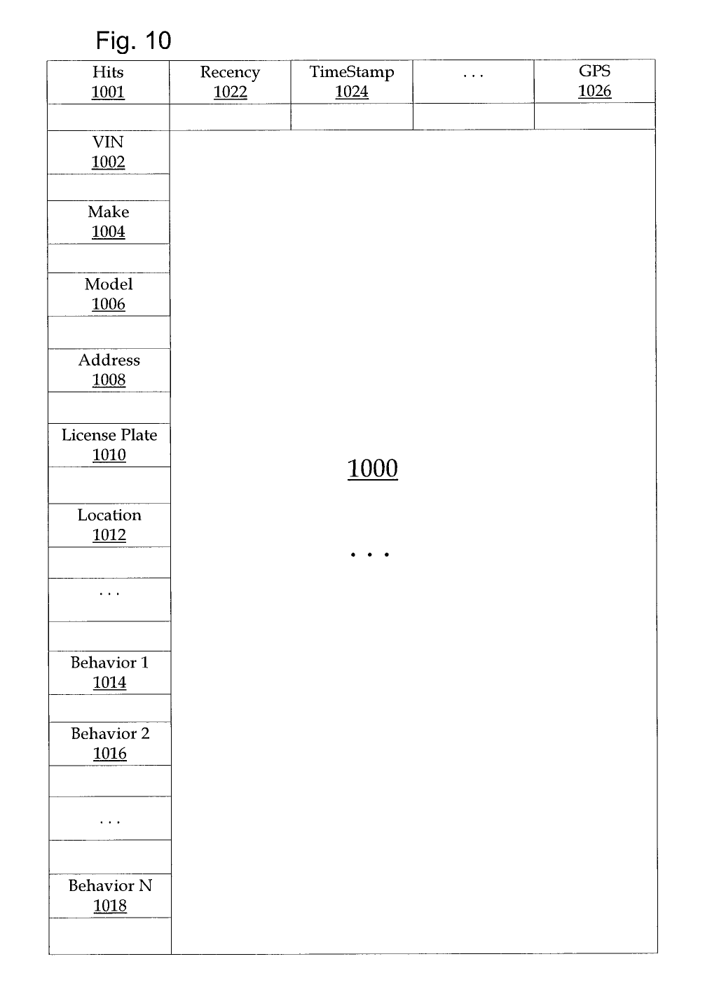

Referring now to FIG. 10, recoverability index 1000 may be generated from the LPR data and stored as a logical data structure in one or more relation databases of the system. The recoverability index 1000 may store all forms of data that can be generated form historical LPR data, as well as data received from external databases, such as municipal vehicle databases 326 and the NCIC database 328. Recoverability index 1000 may be stored as a logical data structure in a relational database, such as master database 114. All of the data may be stored by using one or more asset identifying factors as a key. Thus, for each hit 1001 produced by the ALPR systems, the system may associate that data with any combination of identifying factors that the system is able to determine for the hit. In the case of vehicles, this may include VIN 1002, make 1004, model 1006, address 1008, license plate number 1010, and location 1012 of the hit as determined form the geolocation data transmitted with the hit 1001 by the ALPR system. As previously discussed, the system may process the historical LPR data in order to identify one or more patterns of behavior 1014, 1016, 1018 for the vehicle. Each of behaviors 1014, 1016, 1018 for the vehicle may be associated with one or more sets of the identifying factors and stored as an index component for each of those sets. For example, the underlying historical LPR data may be associated with a particular license plate, make, and vehicle model. The system may be able to use the license plate, vehicle make, and model to determine a VIN for the vehicle. Each of the VIN and the license plate, vehicle make, and model may be independently sufficient to identify the vehicle on its own. The system may store two distinct recoverability indices for each of these sets, or may be combine the data into a single recoverability index. In the case of multiple indices identifying the same vehicle by distinct sets of features, any vehicle pattern of behavior 1014, 1016, 1018 that is generated from the historical LPR can be associated with and stored as a component of each of the indices.

For each of the possible sets of identifying factors, a number of aspects surrounding the lead may also be stored as part of the recoverability index. For example, a recoverability index may also include the recency of the LPR data 1022, classification of the vehicle lead (e.g., whether the vehicle was spotted while moving or parked, or whether the vehicle is spotted with a correct license plate or in the correct state), time of the vehicle lead 1024 (e.g., whether the vehicle was spotted during the day versus at night, or that it was spotted during rush hours), quantity of vehicle leads for the same vehicle, concentration of the leads within a given distance from each other, proximity of the vehicle lead to an address of significance to the vehicle of interest as determined from GPS data 1026 or other geospatial data associated with the lead (e.g., home, work, or other address associated with the registered vehicle owner, including those that may be determined from available geospatial data), lead consistency within the same location or a measured period of time, vehicle registration status, frequency of the leads, and the like. Additional factors and components may also be considered by the system as needed. A recoverability index will generally consist of a number of these factors, as well as any inferences that may be generated by processing the LPR data using one or more system algorithms, such as patterns of behavior 1014, 1016, 1018.

Depending on the needs of the particular system user, a recoverability score will generally be calculated using the various aspects of historical LPR data that are stored as components in the recoverability index for the vehicle of interest. Additionally, the recoverability score may be based on the stored patterns of vehicle operation that are generated and determined by one or more system algorithms. These system algorithms may process various aspects of the historical LPR data in order to identify patterns of operation for a particular vehicle or group of vehicles. These patterns will then be stored by the system. The system may also compare newly received data to the stored patterns of operation in order to identify any new patterns of operation and to store those new patterns as a behavior component in the index. For example, the system may process newly received LPR data in order to identify any abnormalities or changes in patterns of vehicle operation that may affect the likelihood that a vehicle can be successfully recovered at a particular location. Any such identified change in vehicle operation can be stored to the recoverability index as a new vehicle behavior. The process for determining the recoverability score, as well as the processes for identifying patterns in vehicle behavior, may also utilize heuristic and optimization approaches to improve the accuracy of the algorithms. For instance, the processes may utilize machine learning or geospatial analysis to assign relative weights to each component of a recoverability index, or to further optimize the processing of LPR data in order to identify patterns of vehicle operation.

The recoverability index can be adapted and used in a number of different, user-specific contexts. For example, in one scenario, the system user may be a financial institution. The financial institution may be a creditor that maintains a portfolio of vehicle loans. As part of the loan initiation process, a debtor will be required to provide identification information as well as vehicle registration and VIN information. A creditor having a portfolio of loans may wish to sell the portfolio to another financial institution. As part of the transaction, the loan portfolio will have to be valued. Typical valuation methods are based solely on objective data and historical measures of performance, such as the average creditworthiness of the respective debtors and the correlations between various levels of creditworthiness and stored data, such as median or average historical default rates for certain incomes or zip codes. These traditional methods rely on statistical analysis of historical recovery rates for particular classes of vehicles in order to project future success rates and to evaluate the portfolio. Using the recoverability index, a creditor is able to more accurately determine not only the ability to recover specific vehicles of interest that may be serving as collateral on a loan in default, but also to project the recoverability of one or more vehicles before issuing a loan or purchasing a portfolio of loans. For example, as discussed further in connection with FIG. 9, a creditor is able to utilize the recoverability index to generate a recoverability score that forecasts whether the target vehicle or previous vehicles of a debtor have been consistently spotted at or near a particular address or location, or whether the debtor is frequently spotted outside of the specified locations on the vehicle registrations.

In other scenarios, a creditor or other financial institution, such as an insurance company or a rental car company, may wish to use the recoverability index to keep track a vehicle of interest for which the institution has a financial interest. In this case, the financial institution may take into consideration the patterns of vehicle operation in order to determine whether the vehicle is being operated in accordance with an expected manner. Similarly, a financial institution may also use the patterns of vehicle operation determined by the recoverability index in order to determine optimal times and locations for reaching a debtor or obligor, or may use the recoverability index to monitor actions of debtors that may be approaching delinquency such that the financial institution may easily locate the debtor in the event of default. It will be apparent to those of ordinary skill in the art that the described applications of the recoverability index are merely exemplary, and that many more embodiments and implementations are envisioned within the spirit and scope of the present disclosure.

FIG. 9 illustrates an exemplary process 900 for utilizing recoverability probabilities to value portfolio assets according to one embodiment. The process may begin when a creditor or other system user wishes to have a portfolio of assets valued. Initially, the system user may perform a screening process to ensure that the user is authorized to receive data pertaining to a particular asset, for example, by virtue of a security interest (902). Once a system user has been screened, the user submits the portfolio of assets, which is received by the system (904). The user may submit the portfolio in a number of ways, including by transferring the list of assets via a CSV flat file (906). In this case, the system may use an input processor, such as client data feed system 320 as described in connection with FIG. 3, to process the information in the CSV file in batch processing to extract the information corresponding to vehicles of interest. Alternatively, the user may be provided with a secure consumer portal that is linked to the APIs of the system (908). The secure portal may be provided as part of user interface 716 described in connection with FIG. 7. In this scenario, the information describing vehicles of interest, as well as the particular parameters to be used in generating the recoverability index, may be sent and uploaded directly to the system using the client's secure portal. Moreover, the system can be accessed and new information can be submitted and updated in real-time.

Once a portfolio is received and imported into the system, the system analyzes the portfolio information determine eligible assets (910). For example, the system may analyze the information received from the CSV file or consumer portal to identify vehicles of interest that the creditor is authorized to track and/or recover (912). Once the vehicles of interests have been identified, the system may then calculate a recoverability index associated with one or more of the vehicles of interest (914). The recoverability index can be generated as described in connection with FIG. 8. The system next identifies patterns of vehicle behavior (916). Patterns of vehicle behaviors may be based on historical details of vehicle operation, such as frequent locations where the vehicle is spotted, typical time of operation, consistency and frequency of particular data (e.g., tendency to drive on a certain highway or to pass through a certain neighborhood), and the like.

The system may then use the identified patterns of behavior in conjunction with the generated recoverability index to calculate a probability of recovery score for a particular user application (918). There are number of applications or aspects of recoverability that a user may be desire to use the recoverability index to calculate a recovery score for. Consequently, the system can use the general recoverability index for a vehicle to calculate a recovery score that takes into account the particular parameters of the index that are relevant to the desired application chosen by the system user (920). For example, if a user wishes to locate the vehicle, such as for repossession, the system may use the recoverability index to determine the likelihood that the vehicle will be found at various locations. The recoverability scores can reflect the likelihood that the vehicle will be located at residential address, a commercial business, or general geographic area. The recoverability score may also indicate the likelihood that the vehicle will be present at any of these locations at a certain time of day or other time period. Likewise, the recoverability index may indicate that the vehicle of interest is often located near other vehicles of interest. This information may be particularly useful to municipalities and law enforcement agencies wishing to track multiple vehicles of interest that are suspected to be involved in related criminal activity. For example, the system may receive a license plate or other identifying information associated with a vehicle that has been involved connection with a crime or an amber alert. The system may utilize the historical LPR data to generate a recoverability index for the vehicle of interest, and to identify one or more locations where the vehicle has spotted, as well a direction or location where the vehicle may be headed. This information can then be utilized by the municipality or law enforcement agency to track the vehicle.

The recoverability index is capable of generating recoverability indices using all permutations and combinations of various index components, and may therefore, be tailored to the specific desired use or business of the system user. Depending on the application, the user may be interested in vehicles that have been spotted in transit, vehicles that are stationary, or vehicles that have been spotted in connection with a particular physical location. Likewise, certain users may be interested in data relating to a single vehicle of interest or to an average recoverability for an entire class of vehicles. For example, in the previously described situation of the financial institution wishing to value an entire portfolio of assets, then the financial institution may be interested in determining the total number of vehicle sightings and average recoverability score for every vehicle in the portfolio. This information allows the financial institution to more accurately value the portfolio assets than has been historical possible using standard metrics.

A number of applications of the recoverability have been identified in connection with the present disclosure. It will be apparent to those of ordinary skill in the art that the described applications of the recoverability index are merely exemplary, and that many more embodiments and implementations are envisioned within the spirit and scope of the present disclosure. The recoverability index is adaptable and scalable and may utilize historical LPR data to generate recovery scores tailor to nearly any application.

The logic, circuitry, and processing described above may be encoded or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for examples, instructions for execution by a processor, controller, or other processing device.

The medium may be implemented as any device that contains, stores, communicates, propagates, or transports executable instructions for use by or in connection with an instruction executable system, apparatus, or device. Alternatively or additionally, the logic may be implemented as analog or digital logic using hardware, such as one or more integrated circuits, or one or more processors executing instructions; or in software in an application programming interface (API) or in a Dynamic Link Library (DLL), functions available in a shared memory or defined as local or remote procedure calls; or as a combination of hardware and software.

In other implementations, the logic may be represented in a signal or a propagated-signal medium. For example, the instructions that implement the logic of any given program may take the form of an electronic, magnetic, optical, electromagnetic, infrared, or other type of signal. The systems described above may receive such a signal at a communication interface, such as an optical fiber interface, antenna, or other analog or digital signal interface, recover the instructions from the signal, store them in a machine-readable memory, and/or execute them with a processor.

The systems may include additional or different logic and may be implemented in many different ways. A processor may be implemented as a controller, microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instructions may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system for ranking asset data probability of recovery, comprising:
a data server configured to receive data corresponding to a plurality of vehicles from a plurality of client sources;
a database in operative communication with the data server and configured to store the received data as information records corresponding to each of the plurality of vehicles;
a user interface in operative communication with the data server and configured to receive a request for historical vehicle data relating to a plurality of vehicle assets; and
an output processor operatively coupled to the data server and configured to generate recoverability indices for the plurality of vehicle assets.

2. The system of claim 1, wherein the recoverability indices represent likelihoods that the vehicle assets may be recovered.

3. The system of claim 1, wherein the request for historical vehicle data includes a vehicle identification number (VIN), a license plate number, a photographic image of a license plate number, or a video stream containing images of a license plate number.

4. The system of claim 1, wherein the received data identifies a vehicle and includes a recency of the data, a time of day the data was generated, a geographic location associated with the data, or a classification of the identified vehicle.

5. The system of claim 1, wherein the user interface is coupled to an input processor that is configured to receive and process the request for historical vehicle data.

6. The system of claim 5, wherein the input processor is further configured to process the request for historical vehicle data to identify a plurality of targeted vehicle assets and a plurality of parameters for generating the recoverability indices for the targeted vehicle assets.

7. The system of claim 1, wherein the output processor is further configured to identify patterns of vehicle behavior the plurality of vehicle assets.

8. The system of claim 7, wherein the recoverability indices are generated based on the identified patterns of vehicle behavior.

9. The system of claim 7, wherein the identifying a pattern of vehicle behavior includes identifying a frequently visited residential or commercial location, a frequently travelled route, or a propensity to be located near another vehicle asset.

10. The system of claim 1, wherein the request for historical vehicle data includes a portfolio of assets containing a plurality of vehicle assets.

11. A non-transitory computer readable storage medium having stored therein data representing instructions executable by a programmed processor for ranking asset data probability of recovery, the storage medium comprising instructions operative for:
receiving data corresponding to a plurality of vehicle from a plurality of client sources;
storing the received data as information records corresponding to each of a plurality of vehicles;
receiving a request for historical vehicle data relating to a plurality of targeted vehicle assets;
generating a recoverability score for the plurality of targeted vehicle assets; and
outputting an index representing a likelihood that the plurality of targeted vehicle assets may be recovered.

12. The storage medium of claim 11, further comprising instructions operative for identifying patterns of vehicle behavior for one or more vehicles in the plurality of targeted vehicle assets.

13. The storage medium of claim 12, wherein the outputted index is calculated using the identified patterns of vehicle behavior.

14. The storage medium of claim 11, further comprising instructions operative for receiving a plurality of parameters for generating the index.

15. The storage medium of claim 14, wherein the index is generated based on the received plurality of parameters and the generated recoverability score.

16. The storage medium of claim 11, wherein the request for historical vehicle data includes a portfolio of assets containing a plurality of vehicle assets.

17. A computer-implemented method using at least one processor for ranking asset data probability of recovery, comprising:
receiving a request for historical data relating to a plurality of vehicle assets;
processing the request to identify a plurality of targeted vehicles;
retrieving data records for the plurality of targeted vehicles, the data records identifying a vehicle and one or more geographic locations associated with the vehicle; and
processing the data records to generate a recoverability index representing the likelihood of recovering the vehicle.

18. The method of claim 17, further comprising identifying a pattern of behavior associated with an operation of the targeted vehicles.

19. The method of claim 18, further comprising generating a recovery score using the generated recoverability index and based on the identified pattern of behavior.

20. The method of claim 17, further comprising displaying the processed data records on a user interface as flags on a map of the one or more geographic locations associated with the vehicle.
